(19) United States
(12) Patent Application Publication
(10) Pub. No.: US 2022/0089889 A1
(43) Pub. Date: Mar. 24, 2022

(54) THERMAL INKJET DYE SUBLIMATION INK

(71) Applicant: Hewlett-Packard Development Company, L.P., Spring, TX (US)

(72) Inventors: Holly N. Keene, San Diego, CA (US); Howard Doumaux, San Diego, CA (US); Nicholas J. Stewart, San Diego, CA (US); David William Jenkins, San Diego, CA (US)

(73) Assignee: Hewlett-Packard Development Company, L.P., Spring, TX (US)

(21) Appl. No.: 17/417,405

(22) PCT Filed: May 7, 2019
(86) PCT No.: PCT/US2019/031162

§ 371 Date: Jun. 23, 2021

(51) Int. Cl. C09D 11/328; C09D 11/037; C09D 11/033; D06P 5/30; D06P 5/28; D06P 5/20

(52) U.S. Cl. CPC C09D 11/328; C09D 11/037; D06P 5/2077; D06P 5/30; D06P 5/006; C09D 11/033

(57) ABSTRACT

An example thermal inkjet dye sublimation ink consists of a disperse dye colorant dispersion, glycerol, 1,2-hexanediol, optionally a water soluble or water miscible organic solvent, optionally an additive, and a balance of water. The disperse dye colorant dispersion is present in an amount ranging from about 1 wt % actives to about 7 wt % actives based on a total weight of the ink. Glycerol is present in an amount ranging from about 5 wt % to about 30 wt % based on the total weight of the ink. 1,2-hexanediol is present in an amount ranging from about 2 wt % to about 25 wt %, and the optional water soluble or water miscible organic solvent present in an amount up to about 7 wt %, each based on the total weight of the ink. The optional additive is selected from the group consisting of a surfactant, a chelating agent, a buffer, a biocide, and combinations thereof.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers, and in particular piezoelectric inkjet printers, are gaining rapid acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating two examples of a printing method;

FIG. 2 is a partially cross-sectioned perspective semi-schematic illustration showing an example of heating resistors of an example thermal inkjet printhead;

FIG. 3 is a partially cross-sectioned perspective semi-schematic illustration showing an example of ink chambers of an example thermal inkjet printhead;

FIG. 4 is a partially cross-sectioned perspective semi-schematic illustration showing an example of a nozzle plate of an example thermal inkjet printhead;

FIG. 5 is a perspective view of an example of a thermal inkjet cartridge;

FIG. 6 is a schematic diagram of two examples of a printing system;

FIGS. 7A and 7B depict black and white reproductions of originally colored photographs of images generated in dye enrichment tests of an example thermal inkjet dye sublimation ink (FIG. 7B) and a comparative ink (FIG. 7A);

FIGS. 8A and 8B depict black and white reproductions of originally colored photographs of images generated in dye enrichment tests of another example thermal inkjet dye sublimation ink (FIG. 8B) and another comparative ink (FIG. 8A);

FIGS. 9A through 9F depict black and white reproductions of originally colored photographs of images generated in dye enrichment tests of example cyan thermal inkjet dye sublimation inks (FIG. 9A through FIG. 9D) and comparative cyan inks (FIG. 9E and FIG. 9F); and

FIGS. 10A through 10F depict black and white reproductions of originally colored photographs of images generated in dye enrichment tests of example black thermal inkjet dye sublimation inks (FIG. 10A through FIG. 10E) and a comparative black ink (FIG. 10F).

### DETAILED DESCRIPTION

Examples of the dye sublimation inks disclosed herein are particularly suitable for thermal inkjet printing, in part because they include glycerol in an amount ranging from about 5 wt % to about 30 wt % and 1,2-hexandiol in an amount ranging from about 2 wt % to about 25 wt %, based on the total weight of the ink.

Glycerol effectively disperses, rather than dissolves, the disperse dye of the colorant dispersion. However, it has been discovered that high loadings of glycerol may cause dye enrichment. The term “dye enrichment,” as used herein refers to the increase in dye density in the first ink drops printed after short idle periods (e.g., 0.2 seconds, 0.3 seconds, 0.4 seconds, 0.5 seconds, 1 second, etc.). The first ink drops printed after the short idle period appear darker than the bulk ink. Then, as more drops are printed, the printed ink drops gradually lighten to the color of the bulk ink. As such, dye enrichment may cause color variation in a printed image.

It has also been unexpectedly discovered that the addition of 1,2-hexandiol reduces the dye enrichment effect. It is believed that as water evaporates from an ink in an inkjet printhead, dye particles may travel toward the nozzles causing localized dye enrichment. It is further believed that 1,2-hexandiol may help retract dye particles away from the inkjet nozzles, which may reduce or eliminate localized dye enrichment.

It has been found that the inks disclosed herein produce prints with better print quality after idle periods than inks that do not include from about 5 wt % to about 30 wt % glycerol and from about 2 wt % to about 25 wt % 1,2-hexandiol. For example, prints without banding, missing spaces, and/or misdirected drops can be achieved after idle periods using the inks disclosed herein.

Throughout this disclosure, a weight percentage that is referred to as “wt % actives” refers to the loading of an active component of a dispersion or other formulation that is present in the thermal inkjet dye sublimation ink. For example, the wt % actives of the disperse dye colorant dispersion accounts for the loading (as a weight percent) of the active dye solids present in the ink, and does not account for the weight of the other components (e.g., co-solvent, water, etc.) of the disperse dye colorant dispersion in the inkjet ink. The term “wt %,” without the term actives, refers to the loading of a 100% active component that does not include other non-active components therein.

The thermal inkjet dye sublimation ink will now be described.

Thermal Inkjet Dye Sublimation Inks

An example of the thermal inkjet dye sublimation ink disclosed herein consists of: a disperse dye colorant dispersion present in an amount ranging from about 1 wt % actives to about 7 wt % actives based on a total weight of the ink; glycerol present in an amount ranging from about 5 wt % to about 30 wt % based on the total weight of the ink; 1,2-hexanediol present in an amount ranging from about 2 wt % to about 25 wt % based on the total weight of the ink; optionally a water soluble or water miscible organic solvent present in an amount up to about 7 wt % based on the total weight of the ink; optionally an additive selected from the group consisting of a surfactant, a chelating agent, a buffer, a biocide, and combinations thereof; and a balance of water. In this example, the thermal inkjet dye sublimation ink consists of the listed components and no additional components (such as shear thinning agents, additional solvents, etc.). In other examples, the thermal inkjet dye sublimation ink comprises the listed components, and other components that do not deleteriously affect the jettability of the ink via a thermal inkjet printhead may be added.

Another example of the thermal inkjet dye sublimation ink is a cyan thermal inkjet dye sublimation ink. An example of the cyan thermal inkjet dye sublimation ink consists of: a cyan disperse dye colorant dispersion present in an amount ranging from about 1 wt % actives to about 7 wt % actives based on a total weight of the ink, the cyan disperse dye colorant dispersion consisting of a single cyan disperse dye, a dispersant, and a dispersion vehicle; glycerol present in an amount ranging from about 6 wt % to about 15 wt % based on the total weight of the ink; 1,2-hexanediol present in an amount ranging from about 2 wt % to about 6 wt % based on the total weight of the ink; optionally a water soluble or water miscible organic solvent present in an amount up to about 7 wt % based on the total weight of the ink; optionally an additive selected from the group consisting of a surfactant, a chelating agent, a buffer, a biocide, and combinations thereof; and a balance of water. In this example, the cyan thermal inkjet dye sublimation ink consists of the listed components and no additional components (such as shear thinning agents, additional solvents, etc.). In other examples, the cyan thermal inkjet dye sublimation ink comprises the listed components, and other components that do not deleteriously affect the jettability of the ink via a thermal inkjet printhead may be added.

Still another example of the thermal inkjet dye sublimation ink is a black thermal inkjet dye sublimation ink. An example of the black thermal inkjet dye sublimation ink consists of: a black disperse dye colorant dispersion present in an amount ranging from about 1 wt % actives to about 7 wt % actives based on a total weight of the ink; glycerol present in an amount ranging from about 9 wt % to about 22 wt % based on the total weight of the ink; 1,2-hexanediol present in an amount ranging from about 3 wt % to about 9 wt % based on the total weight of the ink; optionally a water soluble or water miscible organic solvent present in an amount up to about 7 wt % based on the total weight of the ink; optionally an additive selected from the group consisting of a surfactant, a chelating agent, a buffer, a biocide, and combinations thereof; and a balance of water. In this example, the black thermal inkjet dye sublimation ink consists of the listed components and no additional components (such as shear thinning agents, additional solvents, etc.). In other examples, the black thermal inkjet dye sublimation ink comprises the listed components, and other components that do not deleteriously affect the jettability of the ink via a thermal inkjet printhead may be added.

Dispersed Dye Colorant Dispersion

The disperse dye colorant dispersion includes a disperse dye, a dispersant, and a dispersion vehicle. In some examples, the disperse dye colorant dispersion consists of the listed components and no additional components. In other examples, disperse dye colorant dispersion comprises the listed components, and other components that do not deleteriously affect the jettability of the ink via a thermal inkjet printhead may be added.

In the examples disclosed herein, the disperse dye colorant dispersion may be any color. In an example, the disperse dye colorant dispersion is selected from the group consisting of a black disperse dye colorant dispersion and a cyan disperse dye colorant dispersion.

The disperse dye included in the colorant dispersion may depend on the desired color for the thermal inkjet dye sublimation ink.

In some examples, the disperse dye colorant dispersion is a cyan disperse dye colorant dispersion. In some of these examples, the cyan disperse dye colorant dispersion consists of a single cyan disperse dye, a dispersant, and a dispersion vehicle.

In some examples, the single cyan disperse dye is selected from the group consisting of disperse blue 27, disperse blue 60, disperse blue 73, disperse blue 77 (DB77), disperse blue 87, disperse blue 257, disperse blue 291:1 (DB 291:1), disperse blue 359, disperse blue 360 (DB360), disperse blue 367, disperse blue 72, disperse blue 359, disperse blue 360, disperse blue 14, and disperse blue 19.

In other examples, the disperse dye colorant dispersion is a black disperse dye colorant dispersion. In some of these examples, the black disperse dye colorant dispersion consists of a blend of disperse dyes, a dispersant, and a dispersion vehicle.

In some examples, the blend of disperse dyes is selected from the group consisting of a blend of blue/cyan, brown and yellow disperse dyes, a blend of blue/cyan, orange and violet disperse dyes, a blend of blue/cyan, orange and yellow disperse dyes, and a blend of blue/cyan, magenta, and yellow dyes. An example of a suitable blue/cyan, brown and yellow disperse dye blend includes DB360, disperse brown 27, and disperse yellow 54 (DY54). Some examples of suitable blue/cyan, orange and violet disperse dye blends include DB291:1, disperse orange 29 (DO29) and disperse violet 63, or DB291:1, DO29 and disperse violet 99, disperse violet 72, and/or disperse violet 28. An example of a suitable blue/cyan, orange and yellow dye blend includes DB360, disperse orange 25, and DY54. An example of a suitable blue/cyan, magenta, and yellow dye blend includes DB77 as the blue/cyan, disperse red 92, disperse pink 364, disperse red 60, and/or disperse red 4 as the magenta, and disperse yellow 114, disperse yellow 82, and/or disperse yellow 64 as the yellow. Any of the listed dyes may also be used in other combinations to generate the black disperse dye colorant dispersion.

The disperse dye colorant dispersion may include from about 10 wt % dye solids to about 20 wt % dye solids based on the total weight of the colorant dispersion.

As mentioned above, the disperse dye colorant dispersion also includes a dispersant. The dispersant may be any suitable polymeric dispersant that can disperse the dye and that can be jetted via a thermal inkjet printhead.

Some examples of the polymeric dispersant (which may also be anionic or non-ionic) include polymers or copolymers of acrylics, methacrylics, acrylates, methacrylates, styrene, substituted styrene, α-methylstyrene, substituted α-methyl styrenes, vinyl naphthalenes, vinyl pyrollidones, maleic anhydride, vinyl ethers, vinyl alcohols, vinyl alkyls, vinyl esters, vinyl ester/ethylene copolymers, acrylam ides, and/or methacrylam ides. Some specific examples include a styrene methacrylic acid copolymer, a styrene acrylic acid copolymer, styrene acrylic acid-acrylic ester copolymers, styrene methacrylic acid-acrylic ester copolymers, a styrene maleic anhydride copolymer, polyacrylic acid partial alkyl ester, polyalkylene polyamine, polyacrylates, and vinyl naphthalene-maleic acid copolymers. Another example of a suitable polymeric dispersant is a polyurethane polymer. Still other examples of suitable polymeric dispersants for the disperse dye colorant dispersion include block acrylic copolymers, including A-B block copolymers such as benzyl methacrylate-methacrylic acid diblock copolymers and butyl methacrylate-methacrylic acid diblock copolymers. Still further examples of suitable polymeric dispersants include ABC triblock copolymers, such as benzyl methacrylate-methacrylic acid-ethoxytriethyleneglycol methacrylate triblock copolymers and butyl methacrylate-methacrylic acid-ethoxytriethyleneglycol methacrylate triblock copolymers. Still some other examples of suitable dispersants include low acid value acrylic resins, such as JONCRYL® 586, 671, 675, 678, 680, 683, 690, 693, and 695 (from BASF Corp.).

Examples of polymerization methods used to form the dispersant may include free radical processes, Group Transfer Processes (GTP), radical addition fragmentation (RAFT), atom transfer reaction (ATR), special chain transfer polymerization technology (SCT), and the like. As one example, the dispersant may be a graft acrylic copolymer made by SCT.

In other examples, the disperse dyes may be self-dispersing dyes. The disperse dyes may be exposed to a diazonium treatment (where a charged free radical from a degraded azo attaches to the colorant), or to an ozone treatment (oxidation and functionalization with, e.g., a carboxylic acid), or to a crosslinking treatment to render the dye self-dispersing.

The disperse dye colorant dispersion may include from about 4 wt % dispersant solids to about 7 wt % dispersant solids, based on the total weight of the colorant dispersion.

The mean particle size of the solids (e.g., the disperse dyes and the dispersants) in the disperse dye colorant dispersion may range from about 50 nm to about 200 nm. In another example, the mean particle size of the disperse dye ranges from about 100 nm to about 200 nm. These particle sizes are particularly suitable for being jetted through the orifices of thermal inkjet printheads.

The dispersion vehicle may include water and a water soluble or water miscible co-solvent. Examples of the water soluble or water miscible co-solvent in the disperse dye colorant dispersion may include alcohols (e.g., diols, such as 1,2-propanediol, 1,3-propanediol, etc.), ketones, ketoalcohols, ethers (e.g., the cyclic ether tetrahydrofuran (THF), and others, such as thiodiglycol, sulfolane, 2-pyrrolidone, 1-(2-hydroxyethyl-2-pyrrolidone, 1,3-dimethyl-2-imidazolidinone and caprolactam; glycols such as ethylene glycol, diethylene glycol, tritriethylene glycol, tetraethylene glycol, propylene glycol, dipropylene glycol, tripropylene glycol, trimethylene glycol, butylene glycol, and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, and diethylene glycol monoethyl ether; and lower dialkyl ethers of polyhydric alcohols, such as diethylene glycol dimethyl or diethyl ether.

One or more of these co-solvents may be present in the disperse dye colorant dispersion in respective amounts ranging from about 1 wt % to about 5 wt %, based on the total weight of the colorant dispersion. The balance of the disperse dye colorant dispersion is water, such as purified water or deionized water.

In an example, the disperse dye colorant dispersion has i) a mean particle size (e.g., volume weighted mean diameter as determined by dynamic light scattering (DLS)) ranging from about 50 nm to about 200 nm, and ii) from about 10 wt % dye solids to about 20 wt % dye solids and from about 4 wt % to about 7 wt % dispersant solids, based on the total weight of the colorant dispersion. In this example, the remainder of the disperse dye colorant dispersion may be co-solvent(s) and water.

To form the thermal inkjet dye sublimation ink disclosed herein, the disperse dye colorant dispersion is incorporated into an ink vehicle, which includes the glycerol, 1,2-hexandiol, and water (and in some instances additive(s)).

The disperse dye colorant dispersion may be incorporated into the ink vehicle such that from about 1 wt % actives to about 7 wt % actives are present, based on a total weight of the thermal inkjet dye sublimation ink. In another example, the disperse dye colorant dispersion may be present in an amount ranging from about 3 wt % actives to about 5 wt % actives based on the total weight of the thermal inkjet dye sublimation ink. The wt % actives of the disperse dye colorant dispersion accounts for the loading (as a weight percent) of the active dye solids present in the ink, and does not account for the weight of the other components (e.g., co-solvent, water, etc.) of the disperse dye colorant dispersion in the inkjet ink.

Co-Solvents

As mentioned above, the specific co-solvent system (i.e., from about 5 wt % to about 30 wt % glycerol, from about 2 wt % to about 25 wt % 1,2-hexanediol, and optionally up to about 7 wt % of the water soluble or water miscible organic solvent) may produce prints with good print quality after idle periods.

Glycerol is present in the thermal inkjet dye sublimation ink, in part, because the disperse dye is highly non-soluble in glycerol. Glycerol is also selected, in part, because it also helps to maintain the nozzle health of the thermal inkjet printheads, and to provide substantially consistent print quality over the life of the printhead. The glycerol is present in an amount ranging from about 5 wt % to about 30 wt % based on the total weight of the ink.

1,2-hexanediol is present in the thermal inkjet dye sublimation ink, in part, because it may reduce or eliminate dye enrichment in the thermal inkjet dye sublimation ink. The 1,2-hexanediol is present in an amount ranging from about 2 wt % to about 25 wt % based on the total weight of the ink.

As mentioned above, in some examples, the disperse dye colorant dispersion is a cyan disperse dye colorant dispersion.

In some of these examples (i.e., when the disperse dye colorant dispersion is a cyan disperse dye colorant dispersion), the glycerol is present in an amount ranging from about 6 wt % to about 15 wt % based on the total weight of the ink. In others of these examples, the glycerol is present in an amount ranging from about 6 wt % to less than 9 wt % based on the total weight of the ink. In still others of these examples, the glycerol is present in an amount ranging from about 12 wt % to about 15 wt % based on the total weight of the ink.

In some examples when the disperse dye colorant dispersion is a cyan disperse dye colorant dispersion, the 1,2-hexanediol is present in an amount ranging from about 2 wt % to about 6 wt % based on the total weight of the ink. In others of these examples, the 1,2-hexanediol is present in an amount of about 3 wt % based on the total weight of the ink.

In some examples when the disperse dye colorant dispersion is a cyan disperse dye colorant dispersion, the glycerol is present in an amount ranging from about 6 wt % to about 15 wt % based on the total weight of the ink; and the 1,2-hexanediol is present in an amount ranging from about 2 wt % to about 6 wt % based on the total weight of the ink. In others of these examples, the glycerol is present in an amount ranging from about 6 wt % to less than 9 wt % based on the total weight of the ink; and the 1,2-hexanediol is present in an amount of about 3 wt % based on the total weight of the ink. In still others of these examples, the glycerol is present in an amount ranging from about 12 wt % to about 15 wt % based on the total weight of the ink; and the 1,2-hexanediol is present in an amount of about 3 wt % based on the total weight of the ink. In yet others of these examples, the glycerol is present in an amount of about 12 wt % based on the total weight of the ink; and the 1,2-hexanediol is present in an amount of about 3 wt % based on the total weight of the ink. In still others of these examples, the glycerol is present in an amount of about 15 wt % based on the total weight of the ink; and the 1,2-hexanediol is present in an amount of about 3 wt % based on the total weight of the ink.

As also mentioned above, in other examples, the disperse dye colorant dispersion is a black disperse dye colorant dispersion.

In some of these examples (i.e., when the disperse dye colorant dispersion is a black disperse dye colorant dispersion), the glycerol is present in an amount ranging from about 9 wt % to about 23 wt % based on the total weight of the ink. In others of these examples, the glycerol is present in an amount ranging from greater than 16 wt % to about 23 wt % based on the total weight of the ink. In still others of these examples, the glycerol is present in an amount ranging from about 18 wt % to about 22.5 wt % based on the total weight of the ink.

In some examples when the disperse dye colorant dispersion is a black disperse dye colorant dispersion, the 1,2-hexanediol is present in an amount ranging from about 3 wt % to about 9 wt % based on the total weight of the ink. In others of these examples, the 1,2-hexanediol is present in an amount ranging from greater than 7 wt % to about 9 wt % based on the total weight of the ink. In still others of these examples, the 1,2-hexanediol is present in an amount of about 3 wt % based on the total weight of the ink.

In some examples when the disperse dye colorant dispersion is a black disperse dye colorant dispersion, the glycerol is present in an amount ranging from about 9 wt % to about 22 wt % based on the total weight of the ink; and the 1,2-hexanediol is present in an amount ranging from about 3 wt % to about 9 wt % based on the total weight of the ink. In others of these examples, the glycerol is present in an amount ranging from greater than 16 wt % to about 22 wt % based on the total weight of the ink; and the 1,2-hexanediol is present in an amount ranging from greater than 7 wt % to about 9 wt % based on the total weight of the ink. In still others of these examples, the glycerol is present in an amount ranging from about 18 wt % to about 22.5 wt % based on the total weight of the ink; and the 1,2-hexanediol is present in an amount of about 3 wt % based on the total weight of the ink. In yet others of these examples, the glycerol is present in an amount of about 18 wt % based on the total weight of the ink; and the 1,2-hexanediol is present in an amount of about 3 wt % based on the total weight of the ink. In still others of these examples, the glycerol is present in an amount of about 22.5 wt % based on the total weight of the ink; and the 1,2-hexanediol is present in an amount of about 3 wt % based on the total weight of the ink.

The thermal inkjet dye sublimation ink may also include the water soluble or water miscible organic solvent present in an amount up to about 7 wt % based on the total weight of the ink. The disperse dye(s) in the disperse dye colorant dispersion may be more soluble in the water soluble or water miscible organic solvent than in the glycerol, and thus the water soluble or water miscible organic solvent makes up less than 50% of the total solvent content (i.e., glycerol plus 1,2-hexanediol plus the water soluble or water miscible organic solvent, and not including water) so that the disperse dye(s) remain(s) dispersed in the ink vehicle. The water soluble or water miscible organic solvent may be added to the ink vehicle or may be included as the co-solvent from the disperse dye colorant dispersion. In some examples, the co-solvent(s) may be present in the disperse dye colorant dispersion in relatively low amounts (1 wt % to about 5 wt % based on the total weight of the colorant dispersion), and thus a fraction of the co-solvent(s), may be carried over to the ink disclosed herein depending, in part, upon the dispersion solids and the loading of the dispersion in the ink.

In some examples, the water soluble or water miscible organic solvent is present in the ink. In other words, in these examples, the water soluble or water miscible organic solvent is present in an amount ranging from greater than 0 wt % to about 7 wt % based on the total weight of the ink. In other examples, the water soluble or water miscible organic solvent is not present in the ink. In other words, in these examples, the amount of the water soluble or water miscible organic solvent in the ink is 0 wt % based on the total weight of the ink.

In some examples, the water soluble or water miscible organic solvent is selected from the group consisting of glycerol, ethoxylated glycerol, 1,2-propanediol, 1,3-propanediol, dipropylene glycol, 2-pyrrolidone, 2-methyl-1,3-propanediol, tetrahydrofuran, diethylene glycol, and combinations thereof. In some of these examples, at least a portion of the water soluble or water miscible organic solvent is present in a dispersion vehicle of the disperse dye colorant dispersion; and the dispersion vehicle consists of water and the water soluble or water miscible organic solvent.

Additives

Examples of the thermal inkjet dye sublimation ink disclosed herein may also include additive(s), such as a surfactant, a chelating agent, a buffer, a biocide, and combinations thereof.

In an example, the total amount of surfactant(s) in the thermal inkjet dye sublimation ink ranges from about 0 wt % to about 2 wt % (with respect to the weight of the thermal inkjet dye sublimation ink). In another example, the surfactant is present in an amount of 1 wt % or less.

The surfactant(s) may be included in the thermal inkjet dye sublimation ink to aid in jettability, control the viscosity, to improve the lubricity, and/or to prevent agglomeration of the dispersed dye solids. Examples of suitable surfactants include oleth-3-phosphate, non-ionic, low foaming surfactants, such as ethoxylated 2,4,7,9-tetramethyl 5 decyn-4,7-diol (commercially available as SURFYNOL® 465 (HLB 13) from Evonik Industries) and other ethoxylated surfactants (commercially available as SURFYNOL® 440 (HLB 8) from Evonik Industries), or secondary alcohol ethoxylates (commercially available as TERGITOL® 15-S-7 (HLB 12.1), TERGITOL® 15-S-9 (HLB 12.6), etc. from The Dow Chemical Co.). In an example, the additive includes the surfactant, and the surfactant is oleth-3-phosphate, ethoxylated 2,4,7,9-tetramethyl 5 decyn-4,7-diol, or a combination thereof. In some examples, it has been found that the combination of SURFYNOL® 465 and SURFYNOL® 440, together or also in combination with the oleth-3-phosphate, may improve the wetting of the inks disclosed herein.

When oleth-3-phosphate is included, it may be present in an amount ranging from about 0.1 wt % to about 0.75 wt % based on the total weight of the ink. In an example, the oleth-3-phosphate is present in an amount ranging from about 0.2 wt % to about 0.5 wt % based on the total weight of the ink. Oleth-3-phosphate is commercially available as CRODAFOS™ O3A or CRODAFOS™ N-3 acid from Croda. It is believed that the oleth-3-phosphate may aid the chelating agent (when included) in effectively trapping high levels of metal ions present in the ink (e.g., from the colorant dispersion), and that the chelating agent (when included) keeps the oleth-3-phosphate from precipitating out of the ink. This combination may contribute to an unexpected reduction in kogation in the thermal inkjet printhead. Kogation refers to the deposit of dried ink on a heating element of a thermal inkjet printhead, and the combination of the oleth-3-phosphate with the chelating agent assists in preventing the buildup of kogation and extending the life of the printhead.

The chelating agent is another example of an additive that may be included in the ink. When included, the chelating agent is present in an amount greater than 0 wt % actives and less than 0.1 wt % actives based on the total weight of the ink. In an example, the chelating agent is present in an amount ranging from about 0.04 wt % actives to about 0.08 wt % actives based on the total weight of the ink. The wt % actives of the chelating agent accounts for the loading (as a weight percent) of the active chelator/chelating agent present in the ink, and does not account for the weight of other components of the chelating agent solution (e.g., water) in the inkjet ink.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na₃MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

The surfactant and chelating agent, and their respective amounts, may depend, in part, on the colorant dispersion that is included in the ink. In an example, the ink is a black ink, the chelating agent is present in an amount greater than 0 wt % actives and less than 0.1 wt % actives based on the total weight of the ink, and the surfactant is a combination of oleth-3-phosphate and ethoxylated 2,4,7,9-tetramethyl 5 decyn-4,7-diol. In another example, the ink is a cyan ink, the chelating agent is present in an amount greater than 0 wt % actives and less than 0.1 wt % actives based on the total weight of the ink, and the surfactant is ethoxylated 2,4,7,9-tetramethyl 5 decyn-4,7-diol.

In an example, the pH of the thermal inkjet dye sublimation ink ranges from about 7 to about 9.5 at the time of manufacture. In another example, the pH of the thermal inkjet dye sublimation ink ranges from about 8 to about 9 at the time of manufacture. pH adjuster(s), such as a buffer, may be added to the ink to counteract any slight pH drop that may occur over time. The pH may drop from about 0.5 units to about 1 unit over time after being manufactured. As such, the pH of the inks disclosed herein may be lower than the ranges set forth herein, depending, in part, upon how much time has passed since manufacture.

In an example, the total amount of buffer(s) in the ink ranges from 0 wt % to about 0.5 wt % (with respect to the weight of the thermal inkjet dye sublimation ink). In another example, the total amount of buffer(s) in the ink is about 0.1 wt % (with respect to the weight of the thermal inkjet dye sublimation ink).

Examples of some suitable buffers include TRIS (tris(hydroxymethyl)aminomethane or Trizma), bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of biocide(s) in the thermal inkjet dye sublimation ink ranges from about 0 wt % actives to about 0.5 wt % actives (with respect to the weight of the thermal inkjet dye sublimation ink). In another example, the total amount of biocide(s) in the inkjet ink composition is about 0.001 wt % actives to about 0.1 wt % actives (with respect to the weight of the thermal inkjet dye sublimation ink). The wt % actives of the biocide accounts for the loading (as a weight percent) of the active biocidal agent present in the ink, and does not account for the weight of other components of the biocide (e.g., water) in the inkjet ink.

Examples of suitable biocides include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CM IT) and MIT under the tradename KATHON™ (Dow Chemical Co.), and combinations thereof.

Water

It is to be understood that water is not considered a solvent or co-solvent in the inks disclosed herein, but rather is present in addition to the co-solvent system and makes up a balance of the ink. As such, the weight percentage of the water present in the thermal inkjet dye sublimation inks will depend, in part, upon the weight percentages of the other components. The water may be purified or deionized water.

Printing Methods

Referring now to FIG. 1, examples of the dye sublimation ink disclosed herein may be dispensed from a thermal inkjet printhead during examples of the printing method 100.

An example of the printing method 100 comprises: thermal inkjet printing, from a thermal inkjet printhead, a dye sublimation ink: i) directly onto a textile fabric to form an image; or ii) onto a transfer medium to form an image on the transfer medium; and transferring the image from the transfer medium onto a textile substrate; wherein the dye sublimation ink consists of: a disperse dye colorant dispersion present in an amount ranging from about 1 wt % actives to about 7 wt % actives based on a total weight of the ink; glycerol present in an amount ranging from about 5 wt % to about 30 wt % based on the total weight of the ink; 1,2-hexanediol present in an amount ranging from about 2 wt % to about 25 wt % based on the total weight of the ink; optionally a water soluble or water miscible organic solvent present in an amount up to about 7 wt % based on the total weight of the ink; optionally an additive selected from the group consisting of a surfactant, a chelating agent, a buffer, a biocide, and combinations thereof; and a balance of water.

In an example, the thermal inkjet dye sublimation ink is a cyan thermal inkjet dye sublimation ink consisting of: a cyan disperse dye colorant dispersion present in an amount ranging from about 1 wt % actives to about 7 wt % actives based on a total weight of the ink, the cyan disperse dye colorant dispersion consisting of a single cyan disperse dye, a dispersant, and a dispersion vehicle; glycerol present in an amount ranging from about 6 wt % to about 15 wt % based on the total weight of the ink; 1,2-hexanediol present in an amount ranging from about 2 wt % to about 6 wt % based on the total weight of the ink; optionally a water soluble or water miscible organic solvent present in an amount up to about 7 wt % based on the total weight of the ink; optionally an additive selected from the group consisting of a surfactant, a chelating agent, a buffer, a biocide, and combinations thereof; and a balance of water.

In another example, the thermal inkjet dye sublimation ink is a black thermal inkjet dye sublimation ink consisting of: a black disperse dye colorant dispersion present in an amount ranging from about 1 wt % actives to about 7 wt % actives based on a total weight of the ink; glycerol present in an amount ranging from about 9 wt % to about 22 wt % based on the total weight of the ink; 1,2-hexanediol present in an amount ranging from about 3 wt % to about 9 wt % based on the total weight of the ink; optionally a water soluble or water miscible organic solvent present in an amount up to about 7 wt % based on the total weight of the ink; optionally an additive selected from the group consisting of a surfactant, a chelating agent, a buffer, a biocide, and combinations thereof; and a balance of water.

One example of the method 100 (for direct printing) is shown at reference numerals 104 and 104A. Another example of the method 100 (for transfer printing) is shown at reference numerals 104, 1046, and 106. Either example of the method 100 may also include reference numeral 102.

The example of the method 100 shown at reference numerals 104 and 104A includes thermal inkjet printing, from a thermal inkjet printhead, a dye sublimation ink (reference numeral 104) directly onto a textile fabric to form an image (reference numeral 104A).

The example of the method 100 shown at reference numerals 104, 104B, and 106 includes thermal inkjet printing, from a thermal inkjet printhead, a dye sublimation ink (reference numeral 104) onto a transfer medium to form an image on the transfer medium (reference numeral 104B); and transferring the image from the transfer medium onto a textile substrate (reference numeral 106).

A thermal inkjet printhead uses a certain minimum energy to fire ink drops of the proper volume (herein called the turn-on energy). In some instances, it may be desirable to deliver more energy to the average printhead than is sufficient to fire it (called “over-energy”) in order to allow for any uncertainty. However, it has been found that the inks disclosed herein can be printed at an operating energy that includes a margin over the turn-on energy (TOE) for the printhead, wherein the margin ranges from about 10% to about 25% over the TOE. In an example, the margin ranges from about 15% to about 20% over the TOE. In still another example, the margin is about 15% over the TOE. The low over-energy printing may also contribute to the improved performance of the inks disclosed herein. As such, either example of the method 100 may include applying to a heating resistor of the thermal inkjet printhead an operating energy that includes a margin over a turn-on energy (TOE) for the printhead, wherein the margin ranges from about 10% to about 25% over the TOE (as shown at reference numeral 102).

The textile substrate may be polyester fabric, a polyester coated surface, blends of polyester and other materials (e.g., cotton, linen, etc.) as long as polyester is present in an amount of at least 50 wt % and is present at or near the surface of the fabric, nylons, or other fabrics. In one example, the polyester blend includes from about 70 wt % to about 80 wt % of the polyester. Examples of materials that may be coated with polyester include glass, metal, wood, plastics, ceramics, etc.

With direct printing onto the textile, the dye sublimation ink is thermally inkjetted onto the surface of the textile substrate (reference numerals 104 and 104A). Once the dye sublimation ink disclosed herein is thermal inkjet printed directly on the textile, the textile may be exposed to heat, or heat and pressure. The heat, or heat and pressure is sufficient to sublimate the disperse dye so that it converts to a gas and penetrates into the textile. The heat, or heat and pressure may also be sufficient to open up the fibers of the textile substrate and allow the dye to migrate into the fibers. The dye then re-solidifies on the fibers of the textile substrate, which renders the printed image durable, wash-resistant, and colorfast. The heat to initiate sublimation may range from about 182° C. to about 215° C., and the pressure may range from 0 psi to about 100 psi. In an example, the method 100 further comprises exposing the image to a post-treatment process involving heat ranging from about 182° C. to about 215° C., and pressure ranging from 0 psi to about 100 psi.

With transfer printing onto the textile substrate, the dye sublimation ink is thermally inkjetted onto the surface of a transfer medium (reference numerals 104 and 104B). The desired final image may be printed as a mirror image or in reverse on the transfer medium. The transfer medium may be any substrate that will accept the ink and also facilitate the release of the ink. The transfer medium may be a coated paper (from 30 gsm to 150 gsm).

The image on the transfer medium is then transferred to the desired textile substrate (reference numeral 106). To make the transfer, the printed on transfer medium is placed into contact with the textile substrate, and the two are exposed to heat, or heat and pressure to effect the sublimation. The transfer process may involve a heat press or a calender. In the heat press or calender, the printed transfer medium is brought into contact with the textile substrate that is to be imaged. The heat to initiate sublimation may range from about 182° C. to about 215° C., and the pressure may range from 0 psi to about 100 psi. The sublimated dye is converted to a gas and is able to penetrate into the textile substrate it is in contact with. The dye then re-solidifies on the fibers of the textile substrate, which renders the printed image durable, wash-resistant, and colorfast. The heat to initiate sublimation may range from about 182° C. to about 215° C., and the pressure may range from 0 psi to about 100 psi. As mentioned above, in an example, the method 100 further comprises exposing the image to a post-treatment process involving heat ranging from about 182° C. to about 215° C., and pressure ranging from 0 psi to about 100 psi.

The dye sublimation inks disclosed herein are jettable via thermal inkjet printheads and cartridges.

Thermal Inkjet Printheads

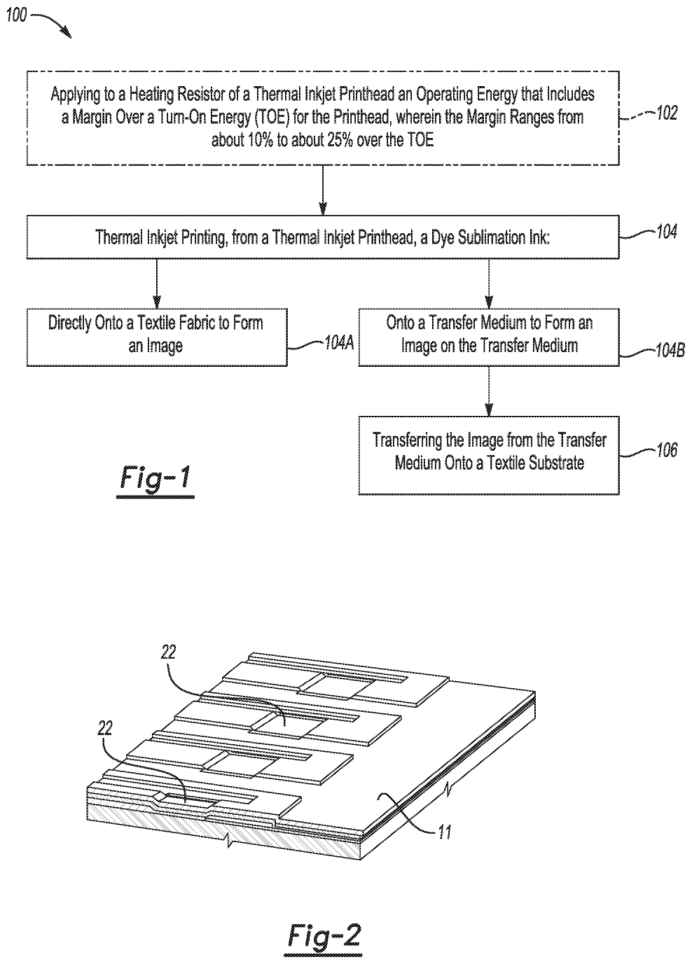

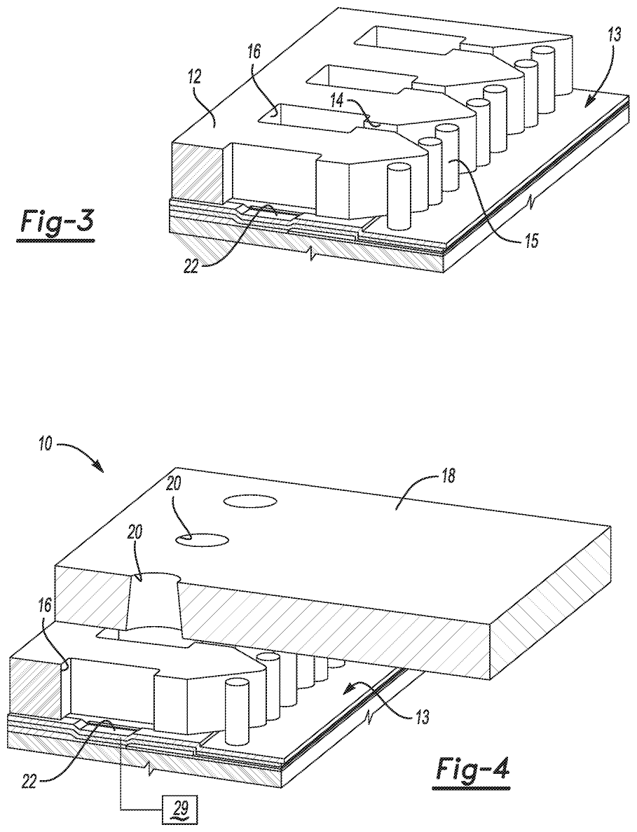

Referring now to FIGS. 2-5 together, an example thermal inkjet printhead 10 may include a base substrate 11 (made, e.g., from silicon or another suitable material). The base substrate 11 may include multiple layers (as shown in FIG. 2) to operatively accommodate suitable electronics to fire printhead nozzles. The printhead 10 further includes a substrate 12 (made, e.g., from a polymeric or other suitable material) defined on the base substrate 11. The substrate 12 has at least one ink feed opening 14 and at least one ink chamber/reservoir 16 defined therein. Four ink feed openings 14 are shown in FIG. 3, though it is to be understood that any desirable number of ink feed openings 14 may be provided. The ink feed opening 14 is in operative and fluid communication with an ink chamber 16 and with an ink channel 13. In an example, one or more pillars 15 may be positioned between the ink channel 13 and the ink feed opening 14 to filter the ink supply before it enters the ink chamber 16.

The ink chamber 16 may be configured to repeatedly receive ink, via ink feed opening 14 and ink channel 13, from an ink supply or source during inkjet printing. In one example, the printhead 10 may be incorporated with an ink cartridge 26 (see FIG. 5), and the ink chamber 16 receives the ink from one or more ink supply regions housing, e.g., a volume of free ink and/or a capillary media configured to store the ink in individual capillaries. In another example, the printhead 10 may be a separate unit operatively connected (via appropriate tubing or the like) to a remotely located ink supply. In other words, printheads 10 can be integrated into the ink cartridge 26 (Integrated Print Head: IPH); or a printhead 10 can be integrated into a printer which has Individual Ink Cartridges (IIC). It is to be understood that other configurations of the thermal inkjet printhead 10 are also contemplated herein.

The printhead 10 further includes a nozzle plate 18 disposed on the substrate 12. In an example, the nozzle plate 18 includes a plurality of orifices 20 (three of which are shown in FIG. 4). The orifice 20 may be in fluid communication with the ink chamber 16 and is configured to eject an ink drop therethrough during an ink ejection process (i.e., the pushing of the ink out of the printhead 10 through the orifice 20 during thermal inkjet printing).

A heating/firing resistor 22 is operatively disposed on the base substrate 11 and proximate to the ink feed opening(s) 14 and ink chamber(s) 16. The heating/firing resistor 22 is also operatively associated with the orifice 20. Although FIG. 4 depicts that the heating/firing resistor 22 is operatively associated with a single orifice 20, it is to be understood that the resistor 22 may also be operatively associated with a plurality of orifices 20.

In an example of a thermal inkjet printhead 10, an array of ink chambers 16 receives liquid ink from the ink channel 13. The heating/firing resistor 22 is located opposite the nozzle/orifice 20 so that ink can collect between it and the orifice 20. The firing of ink droplets may be under the control of a microprocessor (not shown), the signals of which are conveyed by electrical traces to the resistors 22. When electric printing pulses/electrical current is passed through the inkjet firing/heating resistor 22 to heat it to the desired firing temperature, a small portion of the ink next to it vaporizes and ejects a drop of ink from the printhead 10.

FIG. 5 is a semi-schematic illustration of an inkjet print cartridge 26 incorporating a printhead 10 according to an example. The inkjet print cartridge 26 includes an internal ink reservoir (not shown) within the cartridge body 27 and a printhead. The body 27 can include the ink reservoir wholly contained within the cartridge body 27 or, alternatively, can include a chamber inside the cartridge body 27 that is fluidly coupled to one or more off-axis ink reservoirs (not shown).

The printhead includes a nozzle plate 18 including orifices 20 formed in a flexible polymer circuit. The flexible circuit provides for the routing of conductive traces which are connected at one end to electrodes on the substrate and on the other end to contact pads 28. The print cartridge 26 is designed to be installed in a printer so that the contact pads 28 on the front surface of the flexible circuit contact printer electrodes, thereby providing externally generated energization signals to the printhead. Each resistor 22 may act as an ohmic heater when selectively energized by one or more pulses applied sequentially or simultaneously to one or more of the contact pads 28.

A printhead controller 29 is operatively connected to the heating resistor 22, to activate an electrical current to pass the electrical current through the heating resistor 22 to apply an operating energy that, in some examples, includes a margin over a turn-on energy (TOE) for the printhead 10, wherein the margin ranges from about 10% to about 25% over the TOE.

It is to be understood that a single printhead 10 may include multiple (e.g., 400 or some other desirable number) heating/firing resistors 22 and orifices 20. While not shown, it is to be understood that the printhead 10 includes an integrated circuit that selectively routes signals (e.g., from the microprocessor (operatively associated with the printhead controller 29) that is capable of running suitable computer readable instructions) to the desirable resistor(s) 22 and orifice(s) 20 for firing ink drops therefrom to produce images directly on the textile substrate or on a transfer medium.

The print cartridge 26 including the heating/firing resistor 22 may be mounted in a carriage of an inkjet printer (not shown). The carriage may move the print cartridge 26 across a print substrate (e.g., the textile substrate or the transfer medium) in a print/image zone of the printer. The orifice(s) 20 associated with the resistor 22 may be arranged in one or more linear orifice arrays. The orifice(s) 20 may be aligned parallel to the direction in which the print substrate is moved through the printer and perpendicular to the direction of motion of the resistor 22 with the print cartridge 26. Control of the ejection of thermal inkjet dye sublimation ink from each orifice 20 causes characters, or other images, to be printed in a swath across the textile substrate or the transfer medium.

Alternatively, the print cartridge 26 may be a page-wide print cartridge that is in fluid communication with an off-axis ink supply system. The page-wide print cartridge includes a printhead bar that extends the entire print/image zone, and thus the page-wide print cartridge is static during a printing operation. In one example, a single printhead bar extends across the entire print/image zone, and in another example, several printhead bars are aligned to extend across the entire print/image zone.

Printing Systems

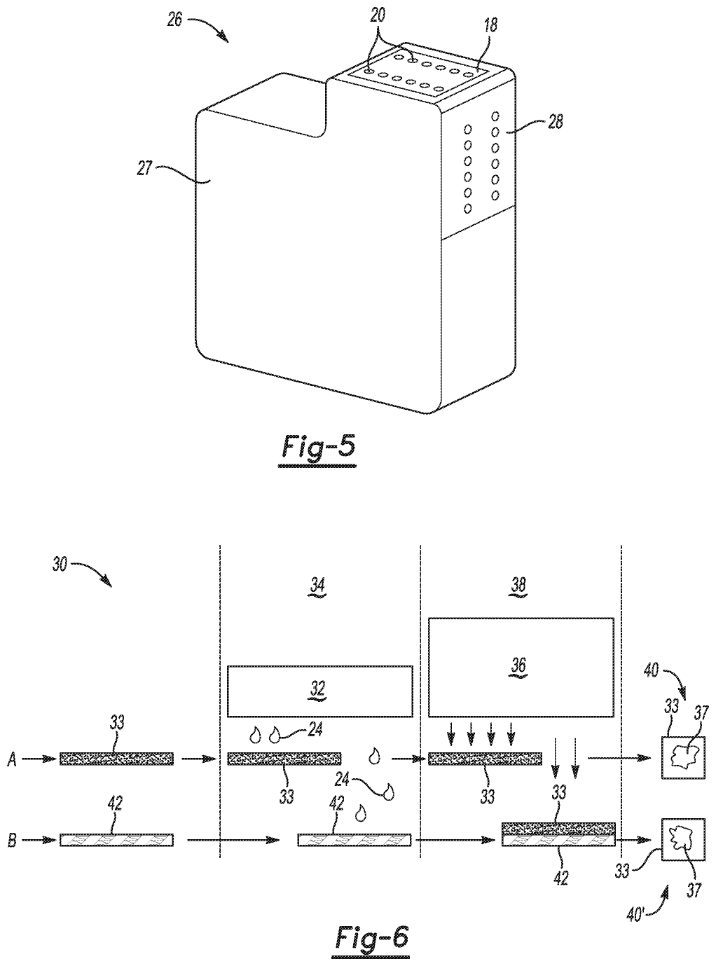

Referring now to FIG. 6, a schematic diagram of a printing system 30 including a thermal inkjet printer 32 in a printing zone 34 of the printing system 30 and a dryer 36 positioned in a sublimation zone 38 of the printing system 30.

In one example, a textile substrate 33 may be transported through the printing system 30 along the path shown by arrow A such that the textile substrate 33 is first fed to the printing zone 34 where an example of the thermal inkjet dye sublimation ink 24 disclosed herein is inkjet printed directly onto the textile substrate 33 by the thermal inkjet printer 32 (for example from the printhead 10 as described above) to form an ink layer on the textile substrate 33. The ink layer disposed on the textile substrate 33 may be heated in the printing zone 34 (for example, the air temperature in the printing zone 34 may range from about 10° C. to about 90° C.) such that water may be at least partially evaporated from the ink layer. As an example, at least partial evaporation means that at least 50% of the water is removed. As another example, at least 80% of the water may be removed during evaporation. It may be desirable for enough water to be removed from an area so that color in the area is not transferred to an adjacent portion/facing surface of the textile substrate 33 during/after rolling that comes in contact with the area. The textile substrate 33 (having the ink layer printed thereon) may then be transported to the sublimation zone 38 where the ink layer is heated or heated and exposed to pressure to sublimate the dye, causing it to penetrate into the textile substrate 33. This forms the printed article 40 including the image 37 formed on the textile substrate 33.

In another example, a transfer medium 42 may be transported through the printing system 30 along the path shown by arrow B such that the transfer medium 42 is first fed to the printing zone 34 where an example of the thermal inkjet dye sublimation ink 24 disclosed herein is inkjet printed directly onto the transfer medium 42 by the thermal inkjet printer 32 (for example, from the printhead 10 as described above) to form an ink layer on the transfer medium 42. The transfer medium 42 (having the ink layer printed thereon) may then be transported to the sublimation zone 38 and placed into contact with the textile substrate 42. In the sublimation zone 38, the ink layer is heated, or heated and exposed to pressure, to sublimate the dye from the transfer medium 42, causing it to penetrate into the penetrable textile substrate 33. This forms the printed article 40′ including the image 37 formed on the textile substrate 33. Dye sublimation transfer printing is also known as blocking and/or backside transfer printing.

To further illustrate the present disclosure, examples are given herein. It is to be understood that these examples are provided for illustrative purposes and are not to be construed as limiting the scope of the present disclosure.

### EXAMPLES

### Example 1

Four examples of the thermal inkjet dye sublimation ink disclosed herein (ex. black 1, ex. cyan 1, ex. black 2, and ex. cyan 2) were prepared. Each of the example inks included from 12 wt % to 22.5 wt % of glycerol and 3 wt % of 1,2-hexandiol. The general formulation of each of the example inks is shown in Table 1, with the wt % active of each component that was used.

TABLE 1

| | | Ex. | Ex. | Ex. | Ex. |
|---|---|---|---|---|---|
| Ingredient | Specific Component | black 1 | black 2 | cyan 1 | cyan 2 |
| Disperse dye | Black disperse dye | 4.5 | 4.5 | — | — |
| colorant dispersion | colorant dispersion | | | | |
| | Cyan disperse dye | — | — | 4.40 | 4.40 |
| | colorant dispersion | | | | |
| Co-solvent | Glycerol | 18.0 | 9.0 | 12.0 | 15.0 |
| | 1,2-hexanediol | 3.0 | 9.0 | 3.0 | 3.0 |
| | Ethoxylated Glycerol | 2.0 | 2.0 | — | — |
| Surfactants | SURFYNOL ® 465 | 0.30 | 0.30 | 0.25 | 0.25 |
| | SURFYNOL ® 440 | — | — | 0.25 | 0.25 |
| | CRODAFOS ™ O3A | 0.20 | 0.20 | 0.20 | 0.20 |
| Chelating Agent | TRILON ® M | 0.040 | 0.040 | 0.020 | 0.020 |
| Buffer | TRIS | 0.100 | 0.100 | 0.100 | 0.100 |
| Biocide | ACTICIDE B20 | 0.040 | 0.040 | 0.040 | 0.040 |
| | ACTICIDE M20 | 0.014 | 0.014 | 0.014 | 0.014 |
| Water | Deionized water | Balance | Balance | Balance | Balance |

Three comparative inks (comp. black 1, comp. cyan 1, and comp. cyan 2) were also prepared. None of the comparative inks included 1,2-hexandiol. The general formulation of each of the comparative inks is shown in Table 2, with the wt % active of each component that was used.

TABLE 2

| | | Comp. | Comp. | Comp. |
|---|---|---|---|---|
| Ingredient | Specific Component | black 1 | cyan 1 | cyan 2 |
| Disperse dye | Black disperse dye | 4.5 | — | — |
| colorant dispersion | colorant dispersion | | | |
| | Cyan disperse dye | — | 4.40 | 4.40 |
| | colorant dispersion | | | |
| Co-solvent | Glycerol | 18.0 | 12.0 | 15.0 |
| | Ethoxylated Glycerol | 2.0 | — | — |
| Surfactants | SURFYNOL ® 465 | 0.30 | 0.25 | 0.25 |
| | SURFYNOL ® 440 | — | 0.25 | 0.25 |
| | CRODAFOS ™ O3A | 0.20 | 0.20 | 0.20 |
| Chelating Agent | TRILON ® M | 0.040 | 0.020 | 0.020 |
| Buffer | TRIS | 0.100 | 0.100 | 0.100 |
| Biocide | ACTICIDE B20 | 0.040 | 0.040 | 0.040 |
| | ACTICIDE M20 | 0.014 | 0.014 | 0.014 |
| Water | Deionized water | Balance | Balance | Balance |

As shown in Tables 1 and 2, comp. black 1 had the same formulation as ex. black 1 except that comp. black 1 did not include any 1,2-hexanediol. Comp. black 1 had the same formulation as ex. black 2 except that comp. black 1 did not include any 1,2-hexanediol and had a different amount of glycerol. The differences between ex. black 1 and ex. black 2 were the amounts of glycerol and 1,2-hexanediol. Comp. cyan 1 had the same formulation as ex. cyan 1 except that comp. cyan 1 did not include any 1,2-hexanediol; and comp. cyan 2 had the same formulation as ex. cyan 2 except that comp. cyan 2 did not include any 1,2-hexanediol.

Each of the example inks and each of the comparative inks were tested to assess the level of dye enrichment experienced by each ink in the firing chamber. To test the level of dye enrichment, two diagnostic plots were printed.

For the first diagnostic plot, a pattern of dots was printed on a drum printer. A sheet of inkjet photo paper was adhered to the drum of the printer, which revolved beneath an inkjet printhead of the printer. The inkjet printhead printed the pattern of dots onto the inkjet photo paper. The dot pattern included a warm-up portion, an enrichment portion, and a test portion. In the warm-up portion, all of the nozzles in the printhead fired drops of ink. In the enrichment portion, half of the nozzles stopped firing to allow dye enrichment to take place in the firing chambers, and half of the nozzles continued to fire to provide a control. The length of the enrichment portion corresponded to 1 second of the non-firing chambers to be idle. In the test portion, the enriched nozzles again fired drops of ink, along with the control nozzles. The color of the enriched dots and the control dots was measured in terms of ΔL* value (i.e., the change in lightness from the warm-up portion to the test portion) and compared to determine the color change due to dye enrichment. A smaller ΔL* indicates that the color was more consistent and that dye enrichment was not as prominent.

For the second diagnostic plot, an image was printed on a large-format scanning inkjet printer. The image included a warm-up bar followed by an area-fill, which was bounded by spit bars that used a portion of the printhead nozzles. While the printheads were scanning but not printing, dye enrichment was allowed to take place in the firing chambers of all the nozzles. Enriched ink was ejected from the some of the firing chambers to create the spit bars. The area-fill allowed side-by-side comparison of the color of the control areas printed by nozzles that were cleared out by printing the spit bars with the color of the test areas printed by nozzles that remained enriched. After printing, the image was transferred by calendering onto a lycra fabric for visual evaluation. Visual evaluation of the degree of dye enrichment included assessment of the contrast between the transferred control areas and the transferred test areas, and assignment of a contrast score between 0 and 5.

A contrast score of 0 indicated that there was no visible contrast/enrichment (0% contrast) between transferred control areas and the transferred test areas. A contrast score of 1 indicated that there was slight contrast/enrichment (greater than 0% contrast to 10% contrast) between transferred control areas and the transferred test areas. A contrast score of 2 indicated that there was noticeable contrast/enrichment (greater than 10% contrast to 20% contrast) between transferred control areas and the transferred test areas. A contrast score of 3 indicated that there was moderate (in some instances undesirable) contrast/enrichment (greater than 20% contrast to 40% contrast) between transferred control areas and the transferred test areas. A contrast score of 4 indicated that there was undesirable contrast/enrichment (greater than 40% contrast to 80% contrast) between transferred control areas and the transferred test areas. A contrast score of 5 indicated that there was severe contrast/enrichment (greater than 80% contrast to 100% contrast) between transferred control areas and the transferred test areas.

The results of the dye enrichment tests for each ink are shown in Table 3. In Table 3, the results of the first diagnostic plot are shown in terms of change in L* value, and the results of the second diagnostic plot are shown in terms of contrast score.

TABLE 3

| | Change in | Contrast |
|---|---|---|
| Ink | L* value | score |
| Comp. black 1 | −13 | 4 |
| Ex. black 1 | −11 | 3 |
| Comp. cyan 1 | −12 | 4 |
| Ex. cyan 1 | −12 | 2 |
| Comp. cyan 2 | −12 | 3 |
| Ex. cyan 2 | — | 2 |

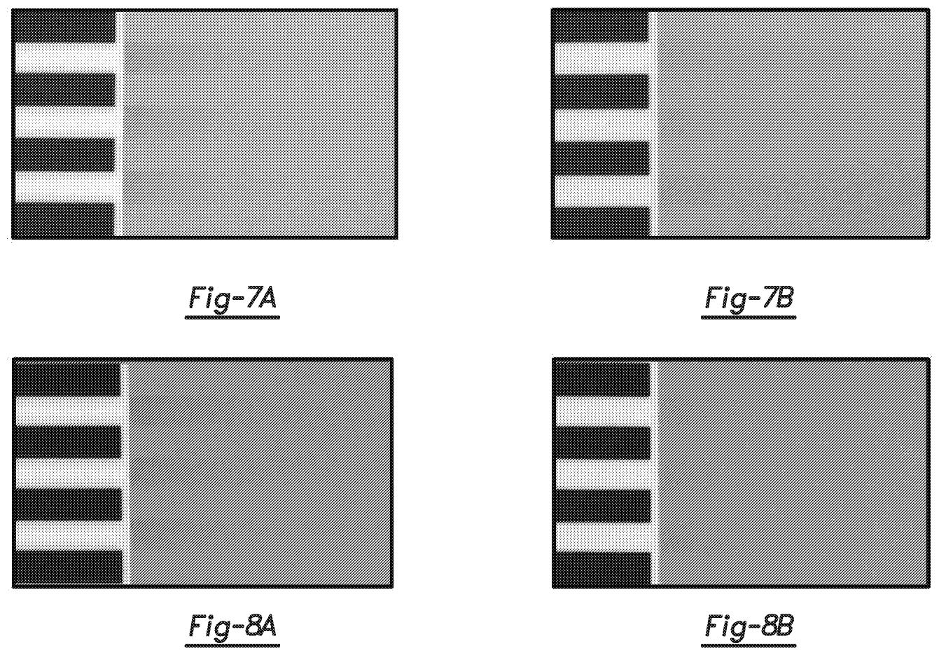

Some of the transferred images from the second diagnostic plot are shown (in black and white) in FIGS. 7A and 7B. The transferred image from the second diagnostic plot generated with comp. cyan 1 is shown in FIG. 7A; and the transferred image from the second diagnostic plot generated with ex. cyan 1 is shown in FIG. 7B.

The transferred image from the second diagnostic plot generated with comp. black 1 is shown (in black and white) in FIG. 8A. The transferred image from the second diagnostic plot generated with ex. black 2 is shown (in black and white) in FIG. 8B.

As shown in Table 3 and FIGS. 7A and 7B, each of the example inks exhibited less dye enrichment than the comparative ink with the same formulation except without any 1,2-hexanediol. In other words, ex. black 1 exhibited less dye enrichment than comp. black 1; ex. cyan 1 exhibited less dye enrichment than comp. cyan 1; and ex. cyan 2 exhibited less dye enrichment than comp. cyan 2. These results indicate that the addition of 1,2-hexanediol to black or cyan, glycerol-containing, thermal inkjet dye sublimation inks reduces dye enrichment of the inks. As shown in FIGS. 8A and 8B, the ex. black 2, with equal amounts of glycerol and 1,2-hexanediol, exhibited less dye enrichment than comp. black 1 with more glycerol and no 1,2-hexanediol.

### Example 2

Four additional examples of the thermal inkjet dye sublimation ink disclosed herein (ex. cyan 3, ex. cyan 4, ex. cyan 5, and ex. cyan 6) were prepared. Two additional comparative inks (comp. cyan 3 and comp. cyan 4) were also prepared. Each of the inks had the same formulation except for the amount of glycerol and the amount of 1,2-hexandiol. Each of the example inks included from 5 wt % to 16 wt % of glycerol and from 3 wt % to 7 wt % of 1,2-hexandiol. Each of the comparative inks included 12 wt % of glycerol and 0 wt % or 1 wt % of 1,2-hexandiol. The general formulation of each of the inks is shown in Table 4, with the wt % active of each component that was used.

TABLE 4

| | | Ex. | Ex. | Ex. | Ex. | Comp. | Comp. |
|---|---|---|---|---|---|---|---|
| Ingredient | Specific Component | cyan 3 | cyan 4 | cyan 5 | cyan 6 | cyan 3 | cyan 4 |
| Disperse | Cyan disperse dye | 4.40 | 4.40 | 4.40 | 4.40 | 4.40 | 4.40 |
| dye colorant | colorant dispersion | | | | | | |
| dispersion | | | | | | | |
| Co-solvent | Glycerol | 6.0 | 12.0 | 16.0 | 5.0 | 12.0 | 12.0 |
| | 1,2-hexanediol | 6.0 | 7.0 | 3.0 | 3.0 | 0.0 | 1.0 |
| Surfactants | SURFYNOL ® 465 | 0.25 | 0.25 | 0.25 | 0.25 | 0.25 | 0.25 |
| | SURFYNOL ® 440 | 0.25 | 0.25 | 0.25 | 0.25 | 0.25 | 0.25 |
| | CRODAFOS ™ O3A | 0.20 | 0.20 | 0.20 | 0.20 | 0.20 | 0.20 |
| Chelating | TRILON ® M | 0.020 | 0.020 | 0.020 | 0.020 | 0.020 | 0.020 |
| Agent | | | | | | | |
| Buffer | TRIS | 0.100 | 0.100 | 0.100 | 0.100 | 0.100 | 0.100 |
| Biocide | ACTICIDE B20 | 0.040 | 0.040 | 0.040 | 0.040 | 0.040 | 0.040 |
| | ACTICIDE M20 | 0.014 | 0.014 | 0.014 | 0.014 | 0.014 | 0.014 |
| Water | Deionized water | Balance | Balance | Balance | Balance | Balance | Balance |

Each of these additional example inks and each of these additional comparative inks were tested to assess the level of dye enrichment experienced by each ink in the firing chamber. To test the level of dye enrichment, an image was printed as described above in reference to the second diagnostic plot in Example 1. After printing, the image was transferred by calendering onto a lycra fabric for visual evaluation. Visual evaluation of the degree of dye enrichment included assessment of the contrast between the transferred control areas and the transferred test areas, and assignment of a contrast score between 0 and 5. The contrast scores indicate the levels of contrast/enrichment described above in Example 1.

The results of the dye enrichment tests for each ink, in terms of contrast score, are shown in Table 5.

TABLE 5

| | Contrast |
|---|---|
| Ink | score |
| Ex. cyan 3 | 2 |
| Ex. cyan 4 | 3 |
| Ex. cyan 5 | 3.5 |
| Ex. cyan 6 | 4 |
| Comp. cyan 3 | 5 |
| Comp. cyan 4 | 5 |

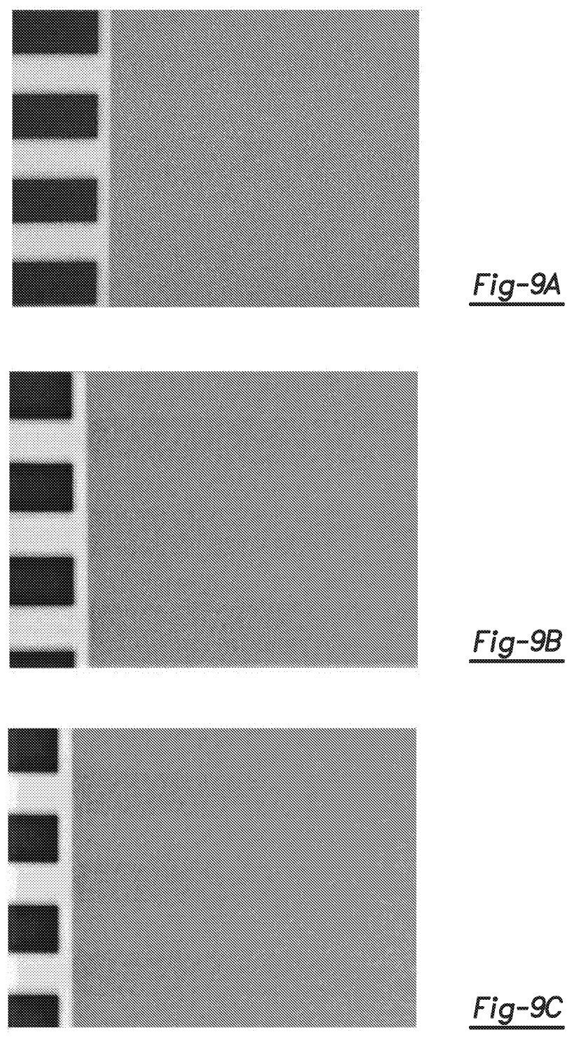

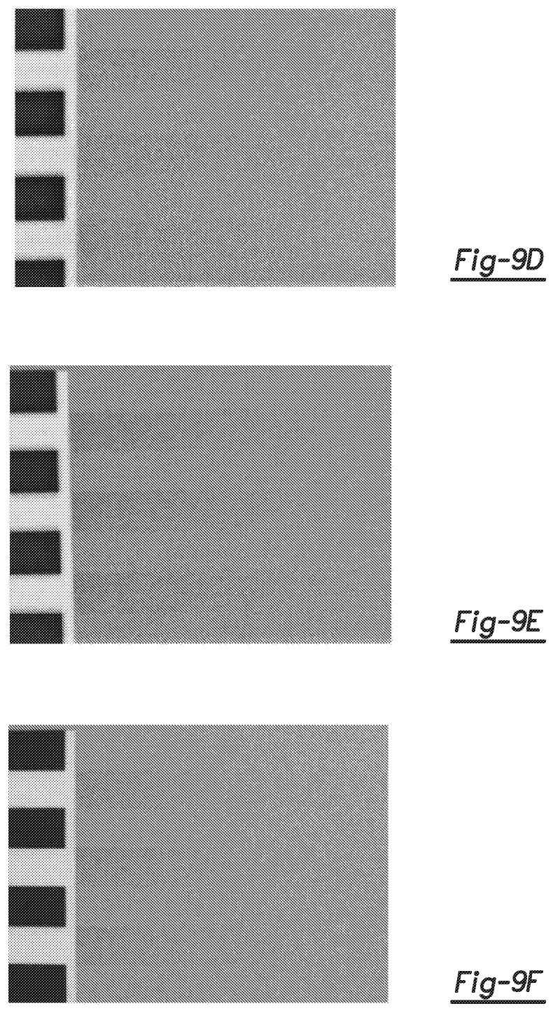

The transferred images are shown (in black and white) in FIGS. 9A-9F. The transferred image generated with ex. cyan 3 is shown in FIG. 9A; the transferred image generated with ex. cyan 4 is shown in FIG. 9B; transferred image generated with ex. cyan 5 is shown in FIG. 9C; transferred image generated with ex. cyan 6 is shown in FIG. 9D; transferred image generated with comp. cyan 3 is shown in FIG. 9E; and transferred image generated with comp. cyan 4 is shown in FIG. 9F.

As shown in Table 5 and FIGS. 9A-9F, each of the example inks exhibited less dye enrichment than the comparative inks. These results indicate that the addition of from about 3.0 wt % to about 7.0 wt % of 1,2-hexanediol to cyan, glycerol-containing, thermal inkjet dye sublimation inks reduces dye enrichment of the inks.

As also shown in Table 5 and FIGS. 9A-9F, ex. cyan 3 had a lower contrast score than all of the other cyan inks. These results indicate that cyan thermal inkjet dye sublimation inks including about 6 wt % of glycerol and about 6 wt % of 1,2-hexanediol have an acceptable level of dye enrichment.

### Example 3

Five additional examples of the thermal inkjet dye sublimation ink disclosed herein (ex. black 3, ex. black 4, ex. black 5, ex. black 6, and ex. black 7) were prepared. One additional comparative ink (comp. black 3) was also prepared. Each of the inks had the same formulation except for the amount of glycerol and the amount of 1,2-hexandiol. Each of the example inks included from 8 wt % to 23 wt % of glycerol and from 2 wt % to 10 wt % of 1,2-hexandiol. The comparative ink included 18 wt % of glycerol and 0 wt % of 1,2-hexandiol. The general formulation of each of the inks is shown in Table 6, with the wt % active of each component that was used.

TABLE 6

| | | Ex. | Ex. | Ex. | Ex. | Ex. | Comp. |
|---|---|---|---|---|---|---|---|
| Ingredient | Specific Component | black 3 | black 4 | black 5 | black 6 | black 7 | black 3 |
| Disperse | Black disperse dye | 4.5 | 4.5 | 4.5 | 4.5 | 4.5 | 4.5 |
| dye colorant | colorant dispersion | | | | | | |
| dispersion | | | | | | | |
| Co-solvent | Glycerol | 9.0 | 16.0 | 23.0 | 9.0 | 8.0 | 18.0 |
| | 1,2-hexanediol | 9.0 | 10.0 | 9.0 | 2.0 | 3.0 | 0.0 |
| Surfactants | SURFYNOL ® 465 | 0.30 | 0.30 | 0.30 | 0.25 | 0.25 | 0.25 |
| | CRODAFOS ™ O3A | 0.20 | 0.20 | 0.20 | 0.20 | 0.20 | 0.20 |
| Chelating | TRILON ® M | 0.040 | 0.040 | 0.040 | 0.040 | 0.040 | 0.040 |
| Agent | | | | | | | |
| Buffer | TRIS | 0.100 | 0.100 | 0.100 | 0.100 | 0.100 | 0.100 |
| Biocide | ACTICIDE B20 | 0.040 | 0.040 | 0.040 | 0.040 | 0.040 | 0.040 |
| | ACTICIDE M20 | 0.014 | 0.014 | 0.014 | 0.014 | 0.014 | 0.014 |
| Water | Deionized water | Balance | Balance | Balance | Balance | Balance | Balance |

Each of these additional example inks and this additional comparative ink were tested to assess the level of dye enrichment experienced by each ink in the firing chamber. To test the level of dye enrichment, an image was printed as described above in reference to the second diagnostic plot in Example 1. After printing, the image was transferred by calendering onto a lycra fabric for visual evaluation. Visual evaluation of the degree of dye enrichment included assessment of the contrast between the transferred control areas and the transferred test areas, and assignment of a contrast score between 0 and 5. The contrast scores indicate the levels of contrast/enrichment described above in Example 1.

The results of the dye enrichment tests for each ink, in terms of contrast score, are shown in Table 7.

TABLE 7

| | Contrast |
|---|---|
| Ink | score |
| Ex. black 3 | 2 |
| Ex. black 4 | 3 |
| Ex. black 5 | Dye depletion |
| Ex. black 6 | 5 |
| Ex. black 7 | 5 |
| Comp. cyan 3 | 5 |

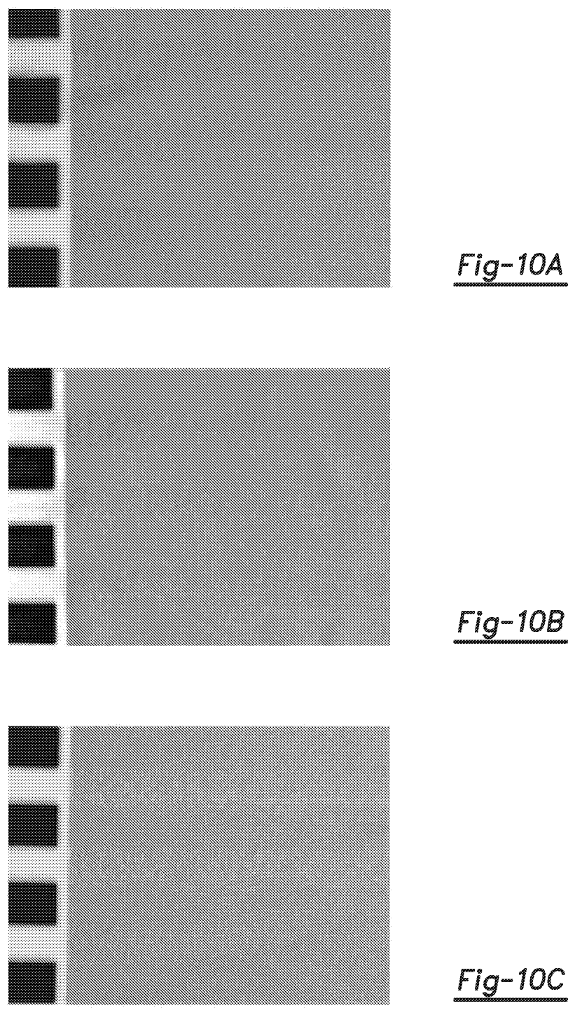

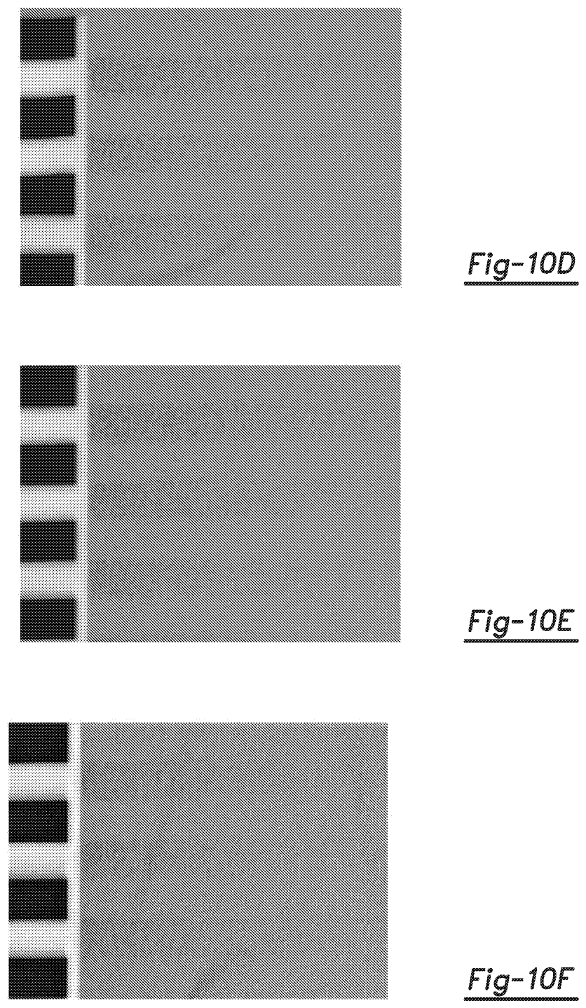

The transferred images are shown (in black and white) in FIGS. 10A-10F. The transferred image generated with ex. black 3 is shown in FIG. 10A; the transferred image generated with ex. black 4 is shown in FIG. 10B; transferred image generated with ex. black 5 is shown in FIG. 10C; transferred image generated with ex. black 6 is shown in FIG. 10D; transferred image generated with ex. black 7 is shown in FIG. 10E; and transferred image generated with comp. cyan 3 is shown in FIG. 10F.

As shown in Table 7 and FIGS. 10A-10F, ex. black 3 had a lower contrast score than all of the other black inks. These results indicate that black thermal inkjet dye sublimation inks including about 9 wt % of glycerol and about 9 wt % of 1,2-hexanediol have an acceptable level of dye enrichment. The overall solvent loading of Example black 5 was higher than the other samples, and the contrast level was outside of the working range. A comparison of the results for example black 3 with example black 6 and example black 7 indicates that a higher loading of 1,2-hexanediol may be more desirable in the black ink when the particular glycerol loadings of example black 6 and example black 7 are used.

It is to be understood that the ranges provided herein include the stated range and any value or sub-range within the stated range, as if such values or sub-ranges were explicitly recited. For example, from about 5 wt % to about 30 wt % should be interpreted to include not only the explicitly recited limits of from about 5 wt % to about 30 wt %, but also to include individual values, such as about 5.9 wt %, about 11.7 wt %, about 17.9 wt %, about 23.97 wt %, etc., and sub-ranges, such as from about 7.13 wt % to about 21.0 wt %, from about 10.25 wt % to about 24.1 wt %, from about 14.31 wt % to about 28.98 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A thermal inkjet dye sublimation ink, consisting of:
a disperse dye colorant dispersion present in an amount ranging from about 1 wt % actives to about 7 wt % actives based on a total weight of the ink;
glycerol present in an amount ranging from about 5 wt % to about 30 wt % based on the total weight of the ink;
1,2-hexanediol present in an amount ranging from about 2 wt % to about 25 wt % based on the total weight of the ink;
optionally a water soluble or water miscible organic solvent present in an amount up to about 7 wt % based on the total weight of the ink;
optionally an additive selected from the group consisting of a surfactant, a chelating agent, a buffer, a biocide, and combinations thereof; and
a balance of water.

2. The thermal inkjet dye sublimation ink as defined in claim 1 wherein the disperse dye colorant dispersion is a cyan disperse dye colorant dispersion.

3. The thermal inkjet dye sublimation ink as defined in claim 2 wherein the cyan disperse dye colorant dispersion consists of a single cyan disperse dye, a dispersant, and a dispersion vehicle.

4. The thermal inkjet dye sublimation ink as defined in claim 3 wherein the single cyan disperse dye is selected from the group consisting of disperse blue 27, disperse blue 60, disperse blue 73, disperse blue 77, disperse blue 87, disperse blue 257, disperse blue 291:1, disperse blue 359, disperse blue 360, disperse blue 367, disperse blue 72, disperse blue 359, disperse blue 360, disperse blue 14, and disperse blue 19.

5. The thermal inkjet dye sublimation ink as defined in claim 2 wherein the glycerol is present in an amount ranging from about 6 wt % to about 15 wt % based on the total weight of the ink.

6. The thermal inkjet dye sublimation ink as defined in claim 2 wherein the 1,2-hexanediol is present in an amount ranging from about 2 wt % to about 6 wt % based on the total weight of the ink.

7. The thermal inkjet dye sublimation ink as defined in claim 1 wherein the disperse dye colorant dispersion is a black disperse dye colorant dispersion.

8. The thermal inkjet dye sublimation ink as defined in claim 7 wherein the glycerol is present in an amount ranging from about 9 wt % to about 23 wt % based on the total weight of the ink.

9. The thermal inkjet dye sublimation ink as defined in claim 7 wherein the 1,2-hexanediol is present in an amount ranging from about 3 wt % to about 9 wt % based on the total weight of the ink.

10. The thermal inkjet dye sublimation ink as defined in claim 7 wherein:
the glycerol is present in an amount ranging from greater than 16 wt % to about 22 wt % based on the total weight of the ink; and
the 1,2-hexanediol is present in an amount ranging from greater than 7 wt % to about 9 wt % based on the total weight of the ink.

11. The thermal inkjet dye sublimation ink as defined in claim 1 wherein the water soluble or water miscible organic solvent is selected from the group consisting of glycerol, ethoxylated glycerol, 1,2-propanediol, 1,3-propanediol, dipropylene glycol, 2-pyrrolidone, 2-methyl-1,3-propanediol, tetrahydrofuran, diethylene glycol, and combinations thereof.

12. The thermal inkjet dye sublimation ink as defined in claim 11 wherein:
at least a portion of the water soluble or water miscible organic solvent is present in a dispersion vehicle of the disperse dye colorant dispersion; and
the dispersion vehicle consists of water and the water soluble or water miscible organic solvent.

13. A cyan thermal inkjet dye sublimation ink, consisting of:
a cyan disperse dye colorant dispersion present in an amount ranging from about 1 wt % actives to about 7 wt % actives based on a total weight of the ink, the cyan disperse dye colorant dispersion consisting of a single cyan disperse dye, a dispersant, and a dispersion vehicle;
glycerol present in an amount ranging from about 6 wt % to about 15 wt % based on the total weight of the ink;
1,2-hexanediol present in an amount ranging from about 2 wt % to about 6 wt % based on the total weight of the ink;
optionally a water soluble or water miscible organic solvent present in an amount up to about 7 wt % based on the total weight of the ink;
optionally an additive selected from the group consisting of a surfactant, a chelating agent, a buffer, a biocide, and combinations thereof; and
a balance of water.

14. A printing method, comprising:
thermal inkjet printing, from a thermal inkjet printhead, a dye sublimation ink:
i) directly onto a textile fabric to form an image; or
ii) onto a transfer medium to form an image on the transfer medium; and
transferring the image from the transfer medium onto a textile substrate;
wherein the dye sublimation ink consists of:
a disperse dye colorant dispersion present in an amount ranging from about 1 wt % actives to about 7 wt % actives based on a total weight of the ink;
glycerol present in an amount ranging from about 5 wt % to about 30 wt % based on the total weight of the ink;
1,2-hexanediol present in an amount ranging from about 2 wt % to about 25 wt % based on the total weight of the ink;
optionally a water soluble or water miscible organic solvent present in an amount up to about 7 wt % based on the total weight of the ink;
optionally an additive selected from the group consisting of a surfactant, a chelating agent, a buffer, a biocide, and combinations thereof; and
a balance of water.

15. The printing method as defined in claim 14, further comprising exposing the image to a post-treatment process involving heat ranging from about 182° C. to about 215° C., and pressure ranging from 0 psi to about 100 psi.
